(19) United States
(12) Patent Application Publication
(10) Pub. No.: US 2026/0257179 A1
(43) Pub. Date: Sep. 3, 2026

(54) DEAERATOR

(71) Applicant: DIC Corporation, Tokyo (JP)

(72) Inventors: Kazumi Oi, Ichihara-shi (JP); Kazuyasu Kawashima, Ichihara-shi (JP); Akira Sato, Ichihara-shi (JP); Youhei Suganuma, Ichihara-shi (JP)

(73) Assignee: DIC Corporation, Tokyo (JP)

(21) Appl. No.: 18/878,322

(22) PCT Filed: Jun. 22, 2023
(86) PCT No.: PCT/JP2023/023203

§ 371 Date: Dec. 23, 2024

(30) Foreign Application Priority Data
Jun. 27, 2022 (JP) 2022-102628

(51) Int. Cl. B01D 63/06; B01D 19/00

(52) U.S. Cl. CPC B01D 63/06; B01D 19/0031; B01D 2313/243

(57) ABSTRACT

A deaerator includes: a deaerating module having a tube unit that has gas permeability and partitions between a fluid flowing space and a depressurized space; a vacuum piping having a suction pipe portion that is connected to the deaerating module to communicate with the depressurized space in the deaerating module and a discharge pipe portion having an outlet port opened to outside; a discharge device that is configured to be connected to the suction pipe portion and to the discharge pipe portion to discharge a gas from the suction pipe portion to the discharge pipe portion; a housing that has a bottom plate and a front plate erected from the bottom plate and mounts the discharge device above the bottom plate and behind the front plate; and a container having a liquid storage space to store a liquid that is discharged from the outlet port of the discharge pipe portion.

### TECHNICAL FIELD

The present invention relates to a deaerator.

### BACKGROUND ART

In PTL 1, a deaerator that is used, among others, in a liquid chromatography device is disclosed.

### CITATION LIST

### Patent Literature

PTL 1: WO 2007-094242

### SUMMARY OF INVENTION

### Technical Problem

In the deaerator described in PTL 1, a depressurized space in a deaerating module having a tube unit that is installed therein communicates with a discharge device (pump) through a vacuum piping, in which a liquid that flows through the tube unit is deaerated by operating the discharge device. In this device, when the liquid leaks from the tube unit to the depressurized space due to deterioration of the tube unit among other causes, the liquid that has leaked to the depressurized space is discharged from the discharge device by way of the vacuum piping to the deaerator by the action of the discharge device. As a result, equipment including the discharge device that are installed in the deaerator may get wet thereby causing malfunction thereof.

Therefore, an object of one aspect of the present invention is to provide a deaerator in which wetting of the equipment that are installed in the deaerator may be suppressed when the liquid leaks from the tube unit to the depressurized space.

### Solution to Problem

[1] A deaerator according to one aspect of the present invention includes: a deaerating module having a tube unit that has gas permeability and partitions between a fluid flowing space and a depressurized space; a vacuum piping having a suction pipe portion that is connected to the deaerating module to communicate with the depressurized space in the deaerating module and a discharge pipe portion having an outlet port opened to outside; a discharge device that is configured to be connected to the suction pipe portion and to the discharge pipe portion to discharge a gas from the suction pipe portion to the discharge pipe portion; a housing that has a bottom plate and a front plate erected from the bottom plate and mounts the discharge device above the bottom plate and behind the front plate; and a container having a liquid storage space to store a liquid that is discharged from the outlet port of the discharge pipe portion, in which the discharge pipe portion has an inside discharge pipe portion that is located behind the front plate and is connected to the discharge pipe portion and an outside discharge pipe portion that is located in front of the front plate and has the outlet port formed.

In this deaerator, the discharge device is connected to the suction pipe portion that communicates with the depressurized space in the deaerating module and to the discharge pipe portion that has the outlet port opened to outside; thus, when the liquid leaks from the tube unit to the depressurized space due to deterioration of the tube unit or other reasons, the liquid that has leaked to the depressurized space by the action of the discharge device may be discharged from the outlet port of the discharge pipe portion by way of the suction pipe portion, the discharge device, and the discharge pipe portion. Because this deaerator has the container having the liquid storage space to store the liquid that is discharged from the outlet port of the discharge pipe portion, the liquid that is discharged from the outlet port of the discharge pipe portion may be stored in the liquid storage space in the container. Therefore, when the liquid leaks from the tube unit to the depressurized space, it is possible to suppress the wetting of the equipment including the discharge device that are installed in the deaerator by this liquid. Moreover, the outlet port of the discharge pipe portion is formed in the outside discharge pipe portion located in front of the front plate, so that the discharge device and the outlet port of the discharge pipe portion are separated by the front plate. Therefore, even if the liquid spills from the container due to tipping over or other reasons, the wetting of the equipment including the discharge device that are installed in the deaerator may be suppressed.

[2] In the deaerator as described in [1], the deaerator may further include a control unit that controls activation and deactivation of the discharge device, and the housing may mount the control unit above the bottom plate and behind the front plate. In this deaerator, the control unit is located behind the front plate, so that the control unit and the outlet port of the discharge pipe portion are separated by the front plate. Therefore, even if the liquid spills from the container due to tipping over or the like, wetting of the control unit by this liquid may be suppressed.

[3] In the deaerator as described in [1] or [2], at least part of the outside discharge pipe portion and the container may be translucent to allow an interior thereof to be seen from outside thereof. When the liquid leaks from the tube unit to the depressurized space due to deterioration of the tube unit or the like, it is desirable to stop the driving of the discharge device as soon as possible. Accordingly, it may be conceived to install a sensor to detect the liquid in any of the suction pipe portion, the discharge device, the discharge pipe portion, and the container, these constituting the path of the liquid that has leaked from the tube unit to the depressurized space. However, installing the sensor increases the cost and complicates the configuration of the deaerator. Moreover, if the sensor becomes malfunction, the liquid may not be detected. In this deaerator, at least part of the outside discharge pipe portion and of the container is translucent to allow the interior thereof to be seen from the outside thereof, making it possible to visually confirm the presence or absence of the liquid through at least part of the outside discharge pipe portion and the container. This makes it possible to judge whether or not the liquid leaks from the tube unit to the depressurized space by visually inspecting the outside discharge pipe portion and the container in front of the front plate, even without suction pipe portion, the discharge device, the discharge pipe portion, and the container. Even in this case, the sensor to detect the liquid may also be installed in any of the suction pipe portion, the discharge device, the discharge pipe portion, and the container.

[4] In the deaerator as described in any one of [1] to [3], the container may be translucent to allow an interior thereof to be seen from outside thereof. In this deaerator, the container is translucent, so that this allows the interior thereof to be seen from the outside thereof, making it possible to visually confirm the presence or absence of the liquid through the container. This makes it possible to judge whether or not the liquid leaks from the tube unit to the depressurized space by visually inspecting the container in front of the front plate, even without installing the sensor to detect the liquid in any of the suction pipe portion, the discharge device, the discharge pipe portion, and the container.

[5] In the deaerator as described in any one of [1] to [4], the outside discharge pipe portion may have a base pipe portion that is continuous from the inside discharge pipe portion and a translucent pipe portion that has the outlet port, and is connected to the base pipe portion, and is translucent to allow an interior thereof to be seen from outside thereof. In this deaerator, the outside discharge pipe portion has a base pipe portion that is continuous from the inside discharge pipe portion, and a translucent pipe portion that is connected to the base pipe portion and has the outlet port; thus, this makes it possible to visually confirm the presence or absence of the liquid through the translucent pipe portion even if the inside discharge pipe portion is not translucent. This makes it possible to judge whether or not the liquid leaks from the tube unit to the depressurized space by visually observing the translucent pipe portion in front of the front plate, even without installing the sensor to detect the liquid in any of the suction pipe portion, the discharge device, the discharge pipe portion, and the container. Moreover, the outside discharge pipe portion is composed of a translucent pipe portion connected to the base pipe portion that is continuous from the inner discharge pipe portion, making it easy to manufacture the discharge pipe portion.

[6] In the deaerator as described in any one of [1] to [5], it may be allowed that the container has an opening that opens the liquid storage space upward, and that the opening of the container is located below the outlet port of the discharge pipe portion. In this deaerator, the opening that opens the liquid storage space of the container upward is located below the outlet port of the discharge pipe portion, so that this allows the liquid that is discharged from the outlet port of the discharge pipe portion to easily enter the container.

[7] In the deaerator as described in [6], the container may have a liquid collecting portion in a funnel shape having a width thereof increased as going upward from the opening. In this deaerator, the container has a liquid collecting portion in a funnel shape having the width thereof increased as going upward from the opening, so that this allows the liquid to be guided into the opening from a position apart from the opening. This allows the liquid that is discharged from the outlet port of the discharge pipe portion to be properly guided into the container, even when the container opening is narrow or the outlet port of the discharge pipe portion is apart from the opening.

[8] In the deaerator as described in any one of [1] to [5], it may be allowed the container to have an opening that opens the liquid storage space to outside, and that the outside discharge pipe portion is inserted into the liquid storage space through the opening. In this deaerator, the outside discharge pipe portion is inserted into the liquid storage space through the opening of the container, so that this allows the liquid that is discharged from the outlet port of the discharge pipe portion to easily enter the container.

[9] In the deaerator as described in any one of [1] to [8], at least part of the vacuum piping may be formed of a resin composition containing a polyolefin and a styrene thermoplastic elastomer. In this deaerator, at least part of the vacuum piping is formed of a resin composition containing a polyolefin and a styrene thermoplastic elastomer, so that the vacuum piping may be afforded with excellent solvent resistance, chemical resistance, and durability. In addition, gas permeability may be lowered and the disconnection of the vacuum piping may be suppressed.

### Advantageous Effects of Invention

According to one aspect of the present invention, when the liquid leaks from the tube unit to the depressurized space, soaking of the equipment that are installed in the deaerator in the leaked liquid may be suppressed.

### BRIEF DESCRIPTION OF DRAWINGS

FIG. 1 is a schematic plan view of a deaerator according to one embodiment of the present invention.

FIG. 2 is a schematic side view of the deaerator illustrated in FIG. 1.

FIG. 3 is a schematic front view of the deaerator illustrated in FIG. 1.

FIG. 4 is a schematic cross-sectional view along the IV-IV line in FIG. 3.

FIG. 5 is a schematic cross-sectional view of one example of a deaerating module installed in the deaerator illustrated in FIG. 1.

FIG. 6 is an enlarged cross-sectional view of a portion around a connector portion of the deaerating module illustrated in FIG. 5.

FIG. 7 is an enlarged cross-sectional view of a portion around a vibration-absorbing member of the deaerator illustrated in FIG. 1.

FIG. 8 is a schematic cross-sectional view of a deaerator corresponding to FIG. 4 in another example.

FIG. 9 is a schematic cross-sectional view of a deaerator corresponding to FIG. 4 in another example.

FIG. 10 is a schematic cross-sectional view of a deaerator corresponding to FIG. 4 in another example.

FIG. 11 is a schematic cross-sectional view of a deaerator corresponding to the XI-XI line in FIG. 2 in another example.

FIG. 12 is a schematic cross-sectional view of a deaerator corresponding to FIG. 4 in another example.

FIG. 13 is a schematic cross-sectional view of a deaerator corresponding to FIG. 4 in another example.

FIG. 14 is a schematic side view of a deaerator in another example.

FIG. 15 is an enlarged cross-sectional view of a portion around a vibration-absorbing member of the deaerator illustrated in FIG. 14.

FIG. 16 is a schematic side view of a deaerator in another example.

### DESCRIPTION OF EMBODIMENTS

Hereinafter, a deaerator of an embodiment will be described in detail with reference to the drawings. In all of the drawings, the same or corresponding parts are denoted by the same reference signs and an overlapping description will be omitted.

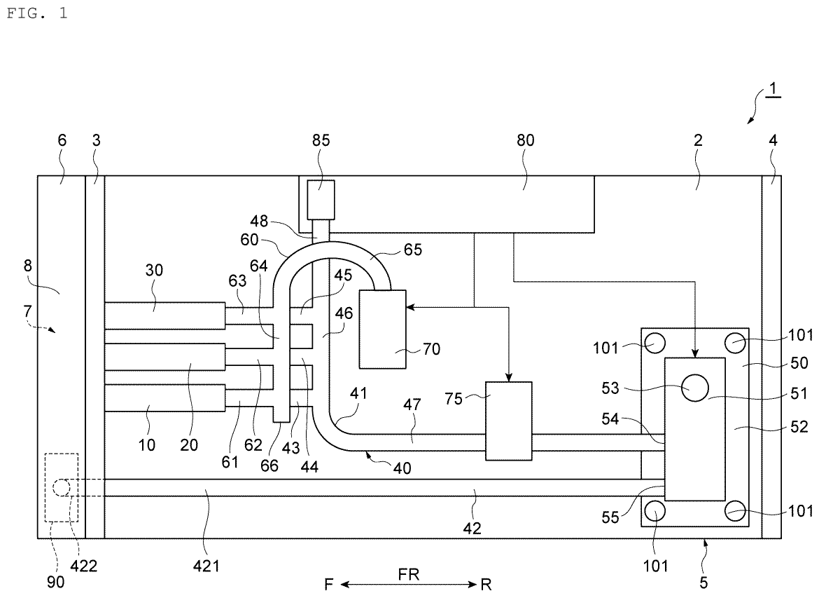

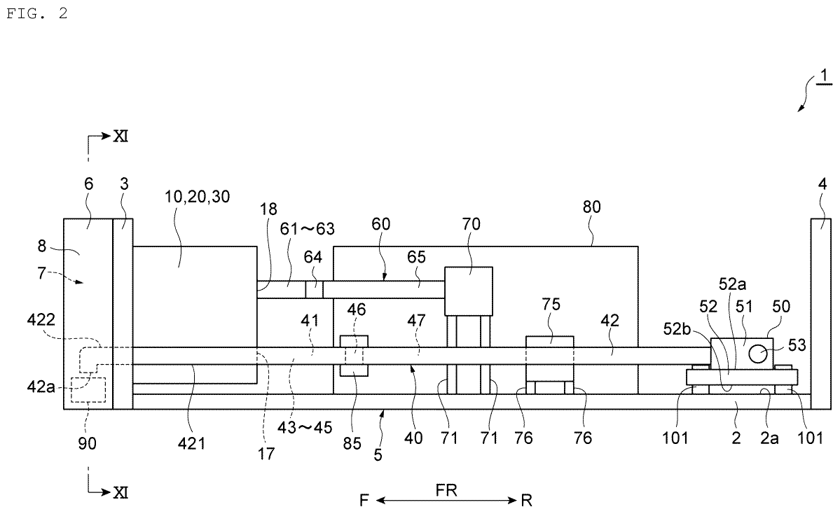

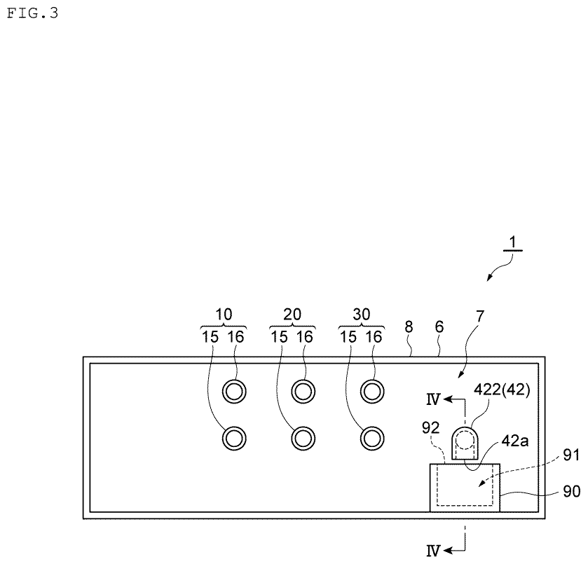

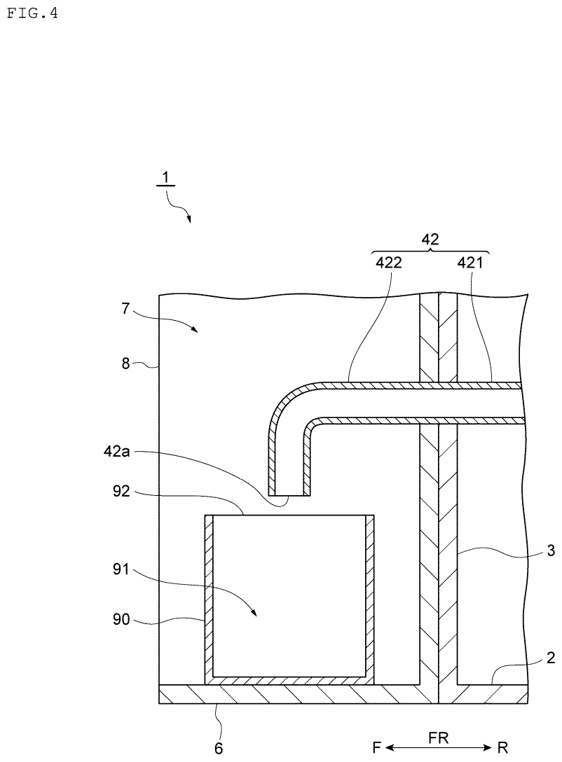

FIG. 1 is a schematic plan view of the deaerator according to one embodiment. FIG. 2 is a schematic side view of the deaerator illustrated in FIG. 1. FIG. 3 is a schematic front view of the deaerator illustrated in FIG. 1. FIG. 4 is a schematic cross-sectional view along the IV-IV line in FIG. 3.

The deaerator 1 illustrated in FIG. 1 to FIG. 4 is, for example, a deaerator for a liquid chromatography and performs a deaerating process on a fluid to be tested in a liquid chromatography. The deaerator 1 may also be used, as a matter of course, for a gas chromatography, a biochemical analyzer, an inkjet filling device, among other devices. As illustrated in FIG. 1 to FIG. 4, a deaerator 1 includes: a housing 5 having a bottom plate 2, a front plate 3, and a rear plate 4; a front panel 6; deaerating modules 10, 20, and 30; a vacuum piping 40, a discharge device 50, an atmospheric release piping 60, an atmospheric release valve 70, a regulating valve 75, a control unit 80, and a container 90.

The bottom plate 2 of the housing 5 defines the bottom part of the deaerator 1. The front plate 3 of the housing 5 is erected from the bottom plate 2 and defines the front part of the deaerator 1. The rear plate 4 of the housing 5 is erected from the bottom plate 2 behind the front plate 3 and opposite to the front plate 3 to define the rear part of the deaerator 1. In the deaerator 1, the direction in which the front plate 3 and the rear plate 4 face each other is referred to as the front-rear direction FR, the direction to the front plate 3 side relative to the rear plate 4 (the direction of the front plate 3 opposite to the rear plate 4) is referred to as a front direction F, and the direction to the rear plate 4 side relative to the front plate 3 (the direction of the rear plate 4 opposite to the front plate 3) is referred to as a rear direction R. Above the bottom plate 2 and between the front plate 3 and the rear plate 4 (the rear direction R of the front plate 3), the housing 5 mounts the discharge device 50, the atmospheric release piping 60, the atmospheric release valve 70, the regulating valve 75, and the control unit 80.

The front panel 6 is attached to the front plate 3 and constitutes the front of the deaerator 1. The front panel 6 has a front panel body 8 that constitutes an accommodation space 7 that is open to the front direction F, and a front panel cover (not illustrated in the drawing) that is removably attached to the front panel body 8 to close the accommodation space 7.

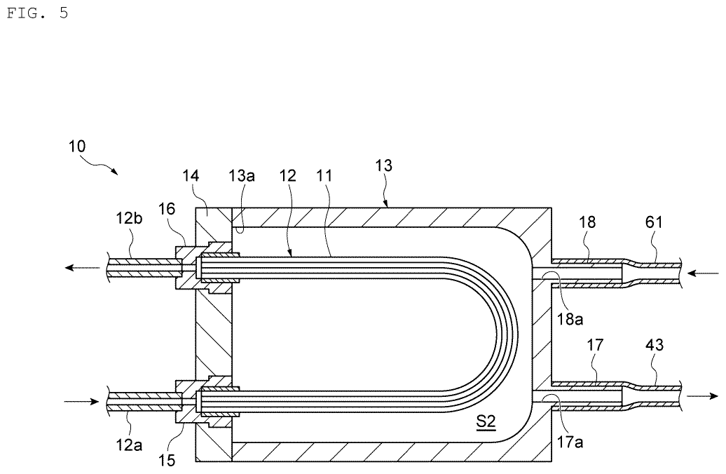

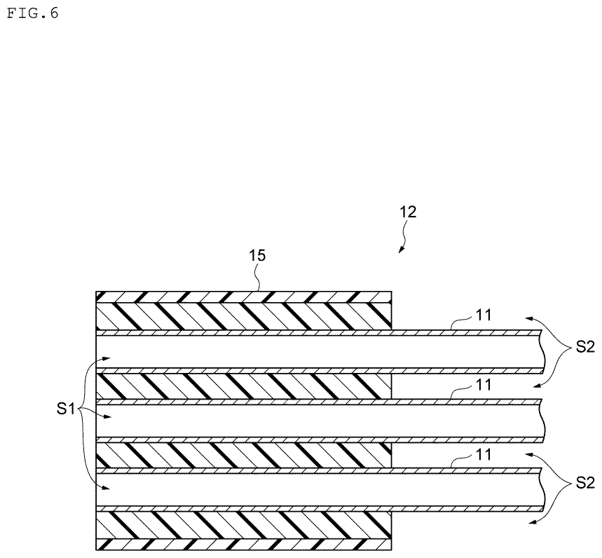

The deaerating modules 10, 20, and 30 have a configuration, for example, as illustrated in FIG. 5. FIG. 5 is a schematic cross-sectional view of one example of the deaerating module that is installed in the deaerator illustrated in FIG. 1. FIG. 6 is an enlarged cross-sectional view of a portion around a connector portion of the deaerating module illustrated in FIG. 5. FIG. 5 illustrates a configuration of the deaerating module 10 as an example, and the other deaerating modules 20 and 30 have a similar configuration. As illustrated in FIG. 5 and FIG. 6, the deaerating module 10 has a tube unit 12 having a plurality of tubes 11 bundled at both ends, in which each tube defines a fluid flowing space S1 in the inside, a housing 13 that accommodates the tube unit 12, a lid 14 that hermetically seals an opening 13a of the housing 13, the connector portions 15 and 16 that connect and fix the tube unit 12 that with penetrates through the lid 14, a discharge nozzle portion 17 that stands out from the housing 13, and a release nozzle portion 18. The discharge nozzle portion 17 has a discharge port 17a that communicates with the depressurized space S2, and the release nozzle portion 18 has a release port 18a that communicates with the depressurized space S2.

In the deaerating module 10, the tube unit 12, which is a gas permeable membrane, partitions the inside of the housing 13 into the fluid flowing space S1 that is an interior space of each of the tubes 11 of the tube unit 12 and the depressurized space S2 that is a space outside the tube unit 12. The fluid flowing space S1 is a region where a liquid is fed, and the liquid that is introduced from an inlet port 12a of the tube unit 12 is fed until a discharge port 12b. The depressurized space S2 is the region where the gas inside of the tube unit is sucked. In the deaerating module 10, a liquid is fed to the fluid flowing space S1 which is the interior space of each of the tubes 11, and the gas is sucked from the depressurized space S2 outside the tubes 11, whereby the liquid that is fed to the tube unit 12 is deaerated.

Each of the tubes 11 that constitute the tube unit 12 is a tubular membrane (gas permeable membrane) that allows a gas to pass through but does not allow a liquid to pass through (see FIG. 6). The material, membrane shape, membrane form, and the like of the tube 11 are not limited. Examples of the material of the tube 11 include fluororesins such as polytetrafluoroethylene (PTFE), tetrafluoroethylene-perfluoroalkyl vinyl ether copolymer (PFA), tetrafluoroethylene-hexafluoropropylene copolymer (FEP), tetrafluoroethylene-ethylene copolymer (ethylene copolymer) (ETFE), polychlorotrifluoroethylene (PCTFE), amorphous fluoropolymer (AF), and polyvinylidene fluoride (PVDF), polypropylene (PP), polymethylpentene (PMP), silicone, polyimide, and polyamide. An example of the amorphous fluoropolymer may be Teflon (registered trademark) AF.

In the deaerating apparatus 1, three deaerating modules 10, 20, and 30 as described above are arranged, but one deaerating module may be arranged, two deaerating modules may be arranged, or four or more deaerating modules may be arranged.

As illustrated in FIG. 1 to FIG. 4, the vacuum piping 40 is the component for discharging the gas in each of the depressurized spaces S2 to the outside. The vacuum piping 40 has a suction pipe portion 41 and a discharge pipe portion 42.

The suction pipe portion 41 is connected to the deaerating modules 10, 20, and 30, and communicates with the respective depressurized spaces S2 of the deaerating modules 10, 20, and 30. The suction pipe portion 41 has discharge piping portions 43 to 45 connected to the respective discharge nozzle portions 17 of the deaerating modules 10, 20, and 30, a discharge collecting portion 46 for collecting the discharge piping portions 43 to 45, a piping 47 to connect the discharge collecting portion 46 to the discharge device 50, and a detection piping portion 48 that communicates the discharge collecting portion 46 with a detector 85. As will be described later, the detector 85 is a barometric pressure sensor that detects the degree of depressurization in the respective depressurized spaces S2 of the deaerating modules 10, 20, and 30, and is installed in the control unit 80.

The discharge pipe portion 42 is connected to the discharge device 50 and has an outlet port 42a that is open to outside in order to discharge the gas that is sent out from the discharge device 50 to the outside of the deaerator 1. The end portion of the discharge pipe portion 42 in the opposite side of the discharge device 50 penetrates through the front plate 3 and extends in the front direction F to the front plate 3. The discharge pipe portion 42 has an inside discharge pipe portion 421 located in the rear direction R of the front plate 3 and an outside discharge pipe portion 422 located in the front direction F of the front plate 3. The end portion of the inside discharge pipe portion 421, opposite to the outside discharge pipe portion 422, is connected to the discharge device 50. The outside discharge pipe portion 422 is housed in the accommodation space 7 in the front panel 6. The outlet port 42a is formed at the end portion of the outside discharge pipe portion 422 opposite to the inner discharge pipe portion 421, and the outside discharge pipe portion 422 is bent so that the outlet port 42a faces downward.

At least part of the suction pipe portion 41 (discharge piping portions 43 to 45, the discharge collecting portion 46, the piping portion 47, and the detection piping 48) and the discharge pipe portion 42, these constituting the vacuum piping 40, is formed of, for example, a resin tube. All or almost all (e.g., excluding a joint portion) of the constituent members of the vacuum piping 40 may be formed of a resin tube. In other words, a plurality of the tubes may be coupled using a joint member or the like to constitute the vacuum piping 40. Such a tube is resistant to a solvent used in a liquid chromatography and is formed of a piping, for example, having a rubber hardness of preferably in the range of 70±30 degrees and an oxygen permeability of 6000 cc (STP) cm/cm²/sec/cmHg×10⁻¹⁰ or less. The rubber hardness is preferably in the range of 70±30 degrees. In order to achieve both an appropriate flexibility to prevent loosening or disconnection at a joint portion and an appropriate durability to suppress deformation, crushing, or blocking of the tube, the lower limit is more preferably 50 degrees or more, even more preferably 55 degrees or more, and particularly preferably 60 degrees or more, and the upper limit is more preferably 95 degrees or less, even more preferably 80 degrees or less, and particularly preferably 75 degrees or less. It is noted that the rubber hardness represents Shore A and may be measured, for example, using a durometer (type A) in accordance with JIS K7312 (1996). In view of excellent durability, the oxygen permeability is preferably 6000 cc (STP) cm/cm²/sec/cmHg×10⁻¹⁰ or less, more preferably 3000 cc (STP) cm/cm²/sec/cmHg×10⁻¹⁰ or less, even more preferably 1000 cc (STP) cm/cm²/sec/cmHg×10⁻¹⁰ or less, particularly preferably 500 cc (STP) cm/cm²/sec/cmHg×10⁻¹⁰ or less, and preferably 0.1 cc (STP) cm/cm²/sec/cmHg×10⁻¹⁰ or more, and more preferably 10 cc (STP) cm/cm²/sec/cmHg×10⁻¹⁰ or more. It is noted that the oxygen permeability represents the oxygen transmission rate and may be measured, for example, in accordance with the ASTM D 1434 Standard.

The material of the tube that constitutes the vacuum piping 40 is not limited as long as it has the properties described above. Examples thereof include vinyl chloride and silicone rubber; polyamides (nylon) such as nylon 6, nylon 66, nylon 11, and nylon 12; polyurethanes; polyolefins such as polyethylene such as low-density polyethylene and linear low-density polyethylene, and polypropylene; fluororesins such as FEP, PFA, ETFE, and PTFE; and thermoplastic elastomers such as polyester thermoplastic elastomers, styrene thermoplastic elastomers, and olefin thermoplastic elastomers. One or two or more these resins may be used. Among the materials described above, a resin composition containing a polyolefin and a thermoplastic elastomer is more preferable as the material of the tube that constitutes the vacuum piping 40, and a resin composition containing a polyolefin and a styrene thermoplastic elastomer is even more preferable.

The vacuum piping 40 formed of the resin composition containing a polyolefin and a thermoplastic elastomer described above is excellent not only in the solvent resistance but also in the low gas permeability. The vacuum piping 40 formed of the resin composition containing a polyolefin and a thermoplastic elastomer described above has a proper flexibility, so that loosening or disconnection at a joint portion of the discharge collecting portion 46 during deaerating operation is prevented, and deformation, crushing, or blocking of the tube is suppressed; thus, an excellent durability may also be obtained. Further, the deaerator 1 according to the present embodiment includes a plurality of deaerating modules and has many joint configurations such as joint portions between the vacuum piping 40 and the deaerating modules 10, 20, and 30, and joint portions of the discharge collecting portions 46 with other portions. The deaerator that is composed of the tubes having such flexibility and durability may also improve the long-term reliability of the deaerator.

The styrene thermoplastic elastomer used for the vacuum piping 40 is a copolymer having at least one styrene block (hard segment) and at least one elastomer block. Vinyl-polydiene, polyisoprene, polybutadiene, polyethylene, polychloroprene, poly(2,3-dimethylbutadiene), or the like may be preferably used as the elastomer block. The elastomer block may be hydrogenated. It is preferable that the elastomer block is hydrogenated, because if so, the solvent resistance and the chemical-resistant performance tend to be higher. Specific examples of the styrene thermoplastic elastomer include styrene-vinylisoprene-styrene triblock copolymer (SIS), styrene-isobutylene diblock copolymer (SIB), styrene-butadiene-styrene triblock copolymer (SBS), styrene-ethylene/butene-styrene triblock copolymer (SEBS), styrene-ethylene/propylene-styrene triblock copolymer (SEPS), styrene-ethylene/ethylene/propylene-styrene triblock copolymer (SEEPS), and styrene-butadiene/butylene-styrene triblock copolymer (SBBS). The styrene thermoplastic elastomers may be used alone or in combination of two or more. Among these, styrene-vinylisoprene-styrene triblock copolymer is preferable because of its superior solvent resistance and chemical-resistant performance. Suitable examples of such styrene-vinylisoprene-styrene triblock copolymer include “FG1901 G Polymer” and “FG1924 G Polymer” available from KRATON CORPORATION and HYBRAR 5127 available from Kuraray Co., Ltd. The hydrogenated vinylisoprene block, HYBRAR 7311, available from Kuraray Co., Ltd. is also suitable.

The lower limit of the range of the amount of styrene block (styrene content) in the styrene thermoplastic elastomer is preferably 1% by mass, more preferably 5% by mass, and even more preferably 10% by mass of the total of styrene block and elastomer block. In this range, higher solvent resistance and chemical-resistant performance tend to be achieved. On the other hand, the upper limit is preferably 30% by mass, and more preferably 20% by mass of the total of styrene block and elastomer block. In this range, solvent resistance and chemical-resistant performance tend to be more excellent.

The lower limit of the range of the amount of styrene thermoplastic elastomer in the resin composition containing a polyolefin and a styrene thermoplastic elastomer is preferably 3% by mass, more preferably 5% by mass, and even more preferably 10% by mass of total of the polyolefin and the styrene thermoplastic elastomer. In this range, higher solvent resistance and chemical-resistant performance tend to be achieved. On the other hand, the upper limit is preferably 30% by mass, more preferably 25% by mass, and even more preferably 20% by mass of total of the polyolefin and the styrene thermoplastic elastomer. In this range, high solvent resistance and chemical-resistant performance tend to be achieved.

In the discharge collecting portion 46, the joint portion that couples the tubes to each other may be formed of a hard plastics (polypropylene) or the like.

The discharge device 50 is connected to the suction pipe portion 41 and to the discharge pipe portion 42 in the vacuum piping 40, and is configured to send the gas from the suction pipe portion 41 to the discharge pipe portion 42.

The discharge device 50 communicates with each of the depressurized spaces S2 in the deaerating modules 10, 20, and 30 by way of the suction pipe portion 41 thereby discharging the gas in each of the depressurized spaces S2 to the outside through the outlet port 42a of the discharge pipe portion 42 in accordance with the control instruction from the control unit 80. The discharge device 50 is composed of, among other things, a pump 51 and a fixing plate 52 to which the pump 51 is fixed. The pump 51 is fixed to an upper surface 52a (opposite to the bottom plate 2) of the fixing plate 52. Therefore, a lower surface 52b of the fixing plate 52 (the side facing the bottom plate 2) is the lowest surface (the surface of the lowest side of the bottom plate 2) of the discharge device 50. The pump 51 is provided with a motor 53 for discharging the gas in each of the depressurized spaces S2 to the outside, a suction port 54 to which the piping portion 47 of the suction pipe portion 41 is connected to inhale the gas from each of the depressurized spaces S2, and a discharge port 55 to which the discharge pipe portion 42 is connected to discharge the inhaled gas to the outside of the deaerator 1. By rotating the motor 53 of the pump 51 in accordance with the control instruction from the control unit 80, the gas in each of the depressurized spaces S2 is sent out from the piping portion 47 to the discharge pipe portion 42 and then discharged to the outside through the outlet port 42a of the discharge pipe portion 42. Examples of the pump 51 include a diaphragm pump such as a diaphragm type dry vacuum pump. The diaphragm pump is a vacuum pump that drives a diaphragm (diaphragm) up and down by rotating a motor so as to transport the gas from the suction port to the discharge port by a vertical movement of this diaphragm. As for the fixing plate 52, a rectangular metal plate is used, for example.

As illustrated in FIG. 1 and FIG. 2, the discharge device 50 is supported by four vibration-absorbing members 101 on the bottom plate 2 of the housing 5. The four vibration-absorbing members 101 have the same configuration; thus, these will be described collectively as the vibration-absorbing member 101, unless specifically mentioned separately. The vibration-absorbing member 101 is the component that dampens vibration and suppresses transmission of vibration. The vibration-absorbing member 101 is interposed between the bottom plate 2 and the discharge device 50 (fixing plate 52) to support the discharge device 50 on the bottom plate 2. The four vibration-absorbing members 101 are located at the four corners of the fixing plate 52 in the plan view and support the discharge device 50 (fixing plate 52) at the four corners of the fixing plate 52. The discharge device 50 is placed at a predetermined height from the upper surface 2a (the side of the discharge device 50) of the bottom plate 2 by the vibration-absorbing member 101.

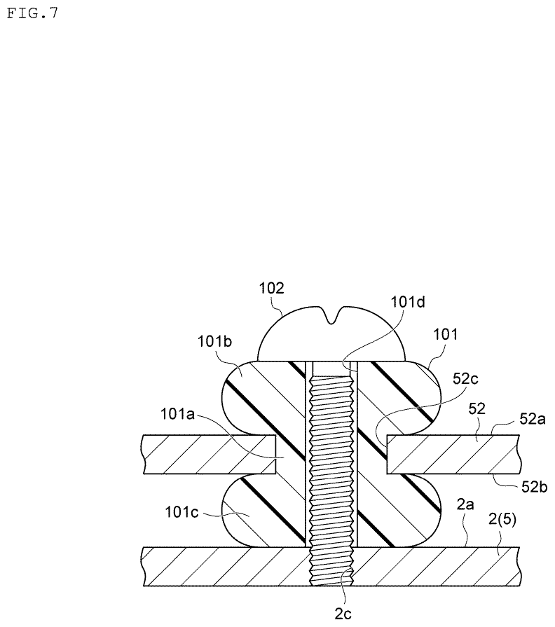

The vibration-absorbing member 101 has a configuration, for example, as illustrated in FIG. 7. FIG. 7 is an enlarged cross-sectional view of a portion around the vibration-absorbing member of the deaerator illustrated in FIG. 1 As illustrated in FIG. 7, the vibration-absorbing member 101 is interposed between the bottom plate 2 and the fixing plate 52 to support the fixing plate 52 on the bottom plate 2. The vibration-absorbing member 101 has: a neck portion 101a inserted into a through hole 52c of the fixing plate 52; an upper widened diameter portion 101b that extends from the neck portion 101a toward the upper surface 52a of the fixing plate 52; a lower widened diameter portion 101c that extends from the neck portion 101a toward the lower surface 52b of the fixing plate 52; and a through hole 101d formed through the neck portion 101a, through the upper widened diameter portion 101b, and through the lower widened diameter portion 101c. The upper widened diameter portion 101b and the lower widened diameter portion 101c are larger in the diameter than the hole diameter of the through hole 52c of the fixing plate 52 so that they do not pass through the through hole 52c of the fixing plate 52. A screw 102 is inserted into the through hole 101d of the vibration-absorbing member 101 from the upper surface 52a side of the fixing plate 52, and is screwed into a screw hole 2c of the bottom plate 2. As a result, the upper widened diameter portion 101b and the lower widened diameter portion 101c sandwich the fixing plate 52 from the upper surface 52a side and from the lower surface 52b side, and the lower widened diameter portion 101c is pressed against the bottom plate 2, so that the discharge device 50 is supported by the bottom plate 2 via the vibration-absorbing member 101. The lower widened diameter portion 101c serves as a spacer between the fixing plate 52 and the bottom plate 2, so that this allows the fixing plate 52 to be arranged at a predetermined height from the bottom plate 2.

As illustrated in FIG. 1 and FIG. 2, the atmospheric release piping 60 is the member that communicates with the respective depressurized spaces S2 in the deaerating modules 10, 20, and 30 to connect the depressurized spaces S2 to the atmospheric release valve 70. The atmospheric release piping 60 has release piping portions 61, 62, and 63 connected to the respective release ports 18a of the deaerating modules 10, 20, and 30, a release collecting portion 64 for collecting the release piping portions 61, 62, and 63, and a piping 65 that connects the release collecting portion 64 to the atmospheric release valve 70.

An end portion 66 opposite to the piping 65 of the release collecting portion 64 of the atmospheric release piping 60 is closed. The atmospheric release piping 60 is formed of the same material as the vacuum piping 40, for example, a resin tube. More specifically, at least part of the release piping portions 61, 62, and 63, the release collecting portion 64, and the piping 65, these constituting the atmospheric release piping 60, is formed of, for example, the resin tube as described above. All or almost all (e.g., excluding joint portions) of the constituent members of the atmospheric release piping 60 may be formed of the resin tube. In other words, a plurality of the resin tubes may be coupled using joint members or the like to constitute the atmospheric release piping 60. The resin tubes as described above are resistant to a solvent that is used in a liquid chromatography and is formed of a piping having a rubber hardness in the range of 70-30 degrees and an oxygen permeability of 6000 cc (STP) cm/cm²/sec/cmHg×10⁻¹⁰ or less. The joint portion of the release collecting portion 64 may be formed of a hard plastic (e.g., polypropylene) or the like, in the same manner as the joint portion of the discharge collecting portion 46.

The atmospheric release valve 70 is a solenoid valve that communicates with one end of the atmospheric release piping 60 and is capable of introducing the atmosphere into the respective depressurized spaces S2 of the deaerating modules 10, 20, and 30 at once through the atmospheric release piping 60 in accordance with the control instruction from the control unit 80. When the deaerating process in the deaerating modules 10, 20, and 30 is over, for example, the atmospheric release valve 70, which is the solenoid valve, opens from the closed state (CLOSE) to the open state (OPEN) within five seconds in accordance with the control instruction from the control unit 80, whereby this opens the depressurized spaces S2 (for example, 1-L volume containers) to an atmosphere within one minute.

The regulating valve 75 is a solenoid valve arranged between the deaerating modules 10, 20, and 30 and the discharge device 50 to regulate the degree of depressurization in the depressurized spaces S2. The regulating valve 75 opens the valve when a depressurization process in the depressurized spaces S2 by the discharge device 50 is being performed, and closes the valve in accordance with the control instruction from the control unit 80 when the degree of depressurization in the depressurized spaces S2 falls within a predetermined range. At this time, the discharge device 50 may stop its discharge action. On the other hand, when the degree of depressurization in the depressurized spaces S2 becomes outside the predetermined range, the valve is opened in accordance with the control instruction from the control unit 80. Both the atmospheric release valve 70 and the regulating valve 75 are placed at a predetermined height from the bottom plate 2 of the housing 5 by a plurality of legs 71 and a plurality of legs 76.

The control unit 80 controls the activation and deactivation of the pump 51 of the discharge device 50. Also, the control unit 80 has the detector 85 to detect the degree of depressurization in the depressurized spaces S2 thereby controlling the operation of the discharge device 50 and the regulating valve 75 in accordance with the detected degree of depressurization. In this control, the atmosphere is discharged by the discharge device 50 so that the degree of depressurization detected by the detector 85 attains a predetermined value, and when the degree of depressurization in the depressurized spaces S2 falls within the predetermined range, the regulating valve 75 is closed and the operation of the discharge device 50 is stopped. When the degree of depressurization detected by the detector 85 falls outside the predetermined range after the regulating valve 75 is closed, the control unit 80 makes the discharge device 50 to operate again to perform the discharge process.

On the other hand, when the deaerating process by the deaerating modules 10, 20, and 30 is over, the control unit 80 controls the action of the discharge device 50 and of the atmospheric release valve 70 in accordance with a stop instruction, for example, from the outside. In this control, after the deaerating process is over, the atmospheric release valve 70 is opened to open the depressurized spaces S2 to the atmosphere at once. After the deaerating process is over, the control may also be performed such that the atmospheric release valve 70 is opened to open the depressurized spaces S2 to an atmosphere at once while the gas discharge operation by the discharge device 50 continues for a predetermined period (e.g., a few seconds).

As illustrated in FIG. 1 to FIG. 4, the container 90 is the container for liquid and is housed in the accommodation space 7 in the front panel 6 located in the front direction F of the front plate 3. When the liquid leaks from the tube unit 12 to the depressurized space S2 due to deterioration of the tube unit 12 or other reasons, the liquid that has leaked to the depressurized space S2 is discharged from the outlet port 42a of the discharge pipe portion 42 by way of the suction pipe portion 41, the discharge device 50, and the discharge pipe portion 42 by driving of the discharge device 50. Therefore, the container 90 receives and stores in it the liquid that has leaked from the tube unit 12 to the depressurized space S2 and is discharged from the outlet port 42a of the discharge pipe portion 42. For this purpose, the container 90 has a liquid storage space 91 that is able to store the liquid and an opening 92 that opens the liquid storage space 91 to the outside. The opening 92 is in the upper side of the liquid storage space 91 and opens the liquid storage space 91 upward. The container 90 is placed in the accommodation space 7 such that the opening 92 is positioned below the outlet port 42a of the discharge pipe portion 42. The front panel body 8 of the front panel 6 may have dents or protrusions for positioning the container 90.

When the liquid leaks from the tube unit 12 to the depressurized space S2 due to deterioration of the tube unit 12 or other reasons, it is desirable to stop the driving of the discharge device 50 as soon as possible. Accordingly, it may be conceived to install a sensor to detect the liquid in any of the suction pipe portion 41, the discharge device 50, the discharge pipe portion 42, and the container 90, these constituting the path of the liquid that has leaked from the tube unit 12 to the depressurized space S2. However, installing the sensor not only increases the cost but also complicates the configuration of the deaerator 1. Moreover, if the sensor becomes malfunction, the liquid may not be detected. Therefore, at least part of the outside discharge pipe portion 422 and the container 90 is translucent so that the interior thereof may be seen from the outside thereof in order to visually confirm the presence or absence of the liquid in the front direction F of the front plate 3. In this embodiment, the container 90 is translucent; thus, this allows the interior thereof to be seen from the outside thereof.

In this embodiment, the term “translucent” means, for example, that the transmittance of visible light, more specifically the light with a wavelength of 400 to 700 nm, is preferably 60% or more, more preferably 75% or more. On the other hand, in this embodiment, the term “non-translucent” means, for example, that the transmittance of visible light, more specifically the light with a wavelength of 400 to 700 nm, is not within the ranges described above. Therefore, the transmittance of the translucent portion (container 90 in this embodiment) for visible light, more specifically the light with a wavelength of 400 to 700 nm, is, for example, 60% or more, 75% or more, or 90% or more. Although there is no upper limit thereof, from the viewpoint of easy production, the transmittance of visible light, more specifically the light with a wavelength of 400 to 700 nm, of the translucent portion may be, for example, preferably 99% or less, more preferably 95% or less. From the viewpoint of making the liquid easily visible from the outside and easy manufacturing, for example, the transmittance of visible light, more specifically the light with a wavelength of 400 to 700 nm, of the translucent portion may be made, for example, 60% or more and 99% or less, 75% or more and 99% or less, or 75% or more and 95% or less.

As described above, in the deaerator 1 according to this embodiment, the discharge device 50 is connected to the suction pipe portion 41, which is connected to the respective depressurized spaces S2 of the deaerating modules 10, 20, and 30, and to the discharge pipe portion 42, which has the outlet port 42a that is open to the outside; thus, when the liquid leaks from the tube unit 12 to the depressurized space S2 due to deterioration of the tube unit 12 or other reasons, the liquid that has leaked to the depressurized space S2 is discharged by the action of the discharge device 50 from the outlet port 42a of the discharge pipe portion 42 after passing through the suction pipe portion 41, the discharge device 50, and the discharge pipe portion 42. The deaerator 1 is equipped with the container 90 having the liquid storage space 91 for storing the liquid that is discharged from the outlet port 42a of the discharge pipe portion 42; thus, the liquid that is discharged from the outlet port 42a of the discharge pipe portion 42 may be stored in the liquid storage space 91 of the container 90. Therefore, when the liquid leaks from the tube unit 12 to the depressurized space S2, the equipment including the discharge device 50 that are installed in the deaerator 1 may be prevented from getting wet with this liquid. Moreover, the outlet port 42a of the discharge pipe portion 42 is formed in the outside discharge pipe portion 422 that is located in the front direction F of the front plate 3, so that the discharge device 50 and the outlet port 42a of the discharge pipe portion 42 are separated by the front plate. Therefore, even if the liquid spills from the container 90 due to tipping-over of the container 90 or other reasons, the equipment including the deaerator 1 that are installed in the discharge device 50 may be prevented from getting wet with this liquid.

In this deaerator 1, the control unit 80 is located in the rear direction R of the front plate 3, so that the control unit 80 and the outlet port 42a of the discharge pipe portion 42 are separated by the front plate 3. This prevents the control unit 80 from getting wet with the liquid even if the liquid spills from the container 90 due to tipping-over of the container 90 or other reasons.

In this deaerator 1, at least part of the outside discharge pipe portion 422 and the container 90 is translucent to allow the interior thereof to be seen from the outside thereof, making it possible to visually confirm the presence or absence of the liquid through at least part of the outside discharge pipe portion 422 and the container 90. As a result, even without installing the sensor to detect the liquid in any of the suction pipe portion 41, the discharge device 50, the discharge pipe portion 42, and the container 90, it is possible to judge whether or not the liquid leaks from the tube unit 12 to the depressurized space S2 by visually inspecting the outside discharge pipe portion 422 and the container 90 in the front direction F of the front plate 3. Even in this case, any of the suction pipe portion 41, the discharge device 50, the discharge pipe portion 42, and the container 90 may be equipped with the sensor to detect the liquid.

In this deaerator 1, because the container 90 is made translucent so that the interior thereof may be seen from the outside thereof, it is possible to visually confirm the presence or absence of the liquid through the container 90. This makes it possible to judge whether or not the liquid leaks from the tube unit 12 to the depressurized space S2 by visually inspecting the container 90 in the front direction F of the front plate 3, even without installing the sensor to detect the liquid in any of the suction pipe portion 41, the discharge device 50, the discharge pipe portion 42, and the container 90.

In the deaerator 1, the opening 92 that opens upward the liquid storage space 91 of the container 90 is located below the outlet port 42a of the discharge pipe portion 42; thus, this allows the liquid that is discharged from the outlet port 42a of the discharge pipe portion 42 to easily enter the container 90.

In this deaerator 1, at least part of the vacuum piping 40 is formed of a resin composition containing a polyolefin and a styrene thermoplastic elastomer, thereby affording excellent solvent resistance, chemical resistance, and durability. In addition, the gas permeability may be lowered, and disconnection of the vacuum piping 40 may be suppressed.

The embodiment of the present invention has been described above; however, the present invention is not limited to the foregoing embodiment and may be changed or modified as appropriate without departing from the concept of the present invention.

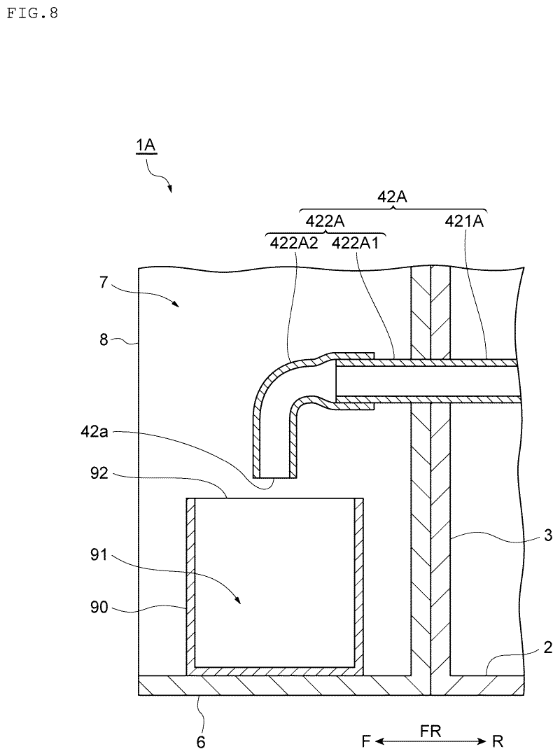

For example, the outside discharge pipe portion may be composed of multiple members, like a deaerator 1A as illustrated in FIG. 8. FIG. 8 is a schematic cross-sectional view of the deaerator corresponding to FIG. 4 in another example. In the deaerator 1A illustrated in FIG. 8, an outside discharge pipe portion 422A of a discharge pipe portion 42A has a base pipe portion 422A1 and a translucent pipe portion 422A2. The base pipe portion 422Al is formed integrally with an inside discharge pipe portion 421A, so that this is continuous from the inside discharge pipe portion 421A. For this reason, the base pipe portion 422A1 is formed of the same material as the inside discharge pipe portion 421A. The translucent pipe portion 422A2 is connected to the base pipe portion 422A1 to form the outlet port 42a of the discharge pipe portion 42A. The translucent pipe portion 422A2 is translucent; thus, this allows the interior thereof to be seen from the outside thereof. In the deaerator 1A, the container 90 may or may not be translucent, because the translucent pipe portion 422A2 is translucent.

Examples of the connecting method between the base pipe portion 422A1 and the translucent pipe portion 422A2 include the method in which the base pipe portion 422A1 and the translucent pipe portion 422A2 are directly connected, and the method in which the base pipe portion 422A1 and the translucent pipe portion 422A2 are indirectly connected via a member that is different from them. Illustrative examples of the direct connecting method between the base pipe portion 422A1 and the translucent pipe portion 422A2 includes press-fitting of the base pipe portion 422Al into the translucent pipe portion 422A2, press-fitting of the translucent pipe portion 422A2 into the base pipe portion 422A1, and adhering the base pipe portion 422Al with the translucent pipe portion 422A2. Illustrative examples of the indirect connecting method of the base pipe portion 422A1 to the translucent pipe portion 422A2 via a member different from them includes press-fitting both ends of an intermediate connecting pipe portion (not illustrated in the drawing) into the base pipe portion 422A1 and into the translucent pipe portion 422A2, and adhering both ends of the intermediate connecting pipe portion (not illustrated in the drawing) with the base pipe portion 422A1 and with the translucent pipe portion 422A2.

In this deaerator 1A, the outside discharge pipe portion 422A has the base pipe portion 422Al that is continuous from the inside discharge pipe portion 421A and the translucent pipe portion 422A2 that is connected to the base pipe portion 422Al to form the outlet port 42a, thereby allowing the interior thereof to be seen from the outside thereof. Thus, even in the case that the inside discharge pipe portion 421A is not translucent, the presence or absence of liquid may be visually confirmed through the translucent pipe portion 422A2. This makes it possible to judge whether or not the liquid leaks from the tube unit 12 to the depressurized space S2 by visually observing the translucent pipe portion 422A2 in the front direction F of the front plate 3, even without installing the sensor to detect the liquid in any of the suction pipe portion 41, the discharge device 50, the discharge pipe portion 42A, and the container 90. Moreover, the outside discharge pipe portion 422A is composed of the base pipe portion 422A1 that is continuous from the inside discharge pipe portion 421A and is connected to the translucent pipe portion 422A2, making it easy to manufacture the discharge pipe portion 42A.

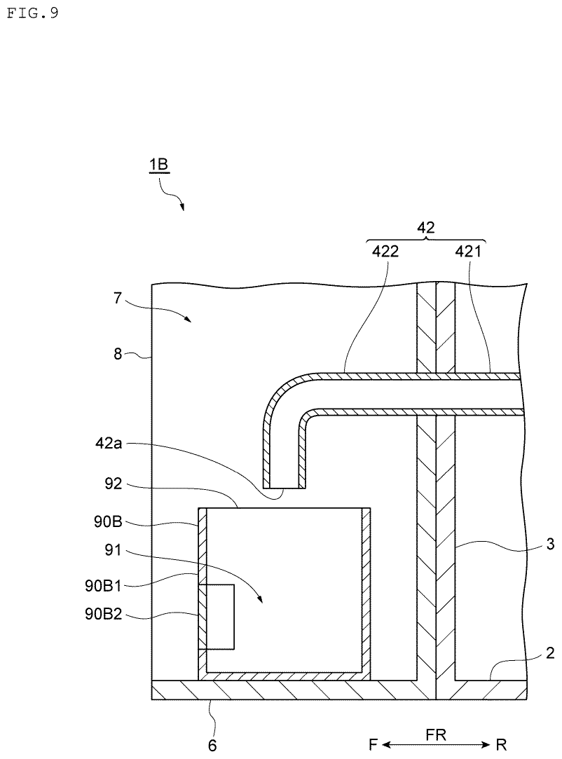

Also, for example, the container may have a non-translucent part that is not translucent and a translucent part that is translucent, like a deaerator 1B as illustrated in FIG. 9. FIG. 9 is a schematic cross-sectional view of the deaerator corresponding to FIG. 4 in another example. In the deaerator 1B illustrated in FIG. 9, a container 90B has a non-translucent portion 90B1, which is not translucent, and a translucent portion 90B2, which allows the interior thereof to be seen from the outside thereof. This deaerator 1B also makes it possible to visually confirm the presence or absence of the liquid through the translucent portion 90B2 of the container 90B, even if the outside discharge pipe portion 422 and the non-translucent portion 90B1 of the container 90B are not translucent. This makes it possible to judge whether or not the liquid leaks from the tube unit 12 to the depressurized space S2 by visually inspecting the translucent portion 90B2 in the front direction F of the front plate 3, even without installing the sensor to detect the liquid in any of the suction pipe portion 41, the discharge device 50, the discharge pipe portion 42, and the container 90B.

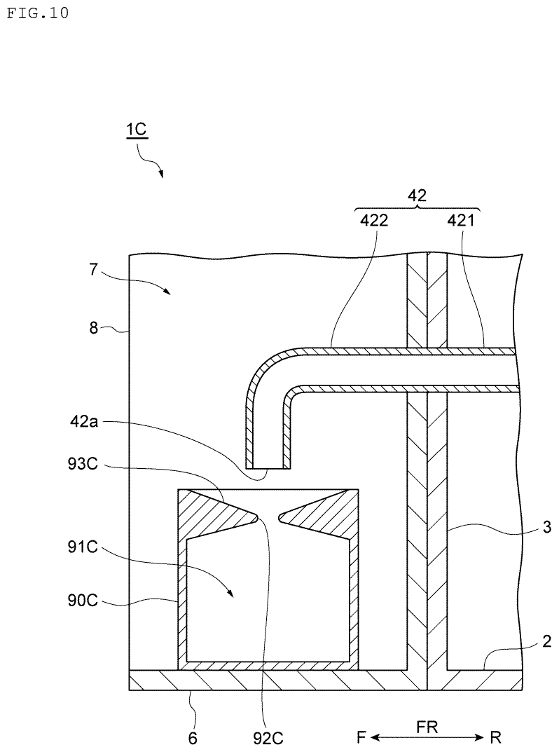

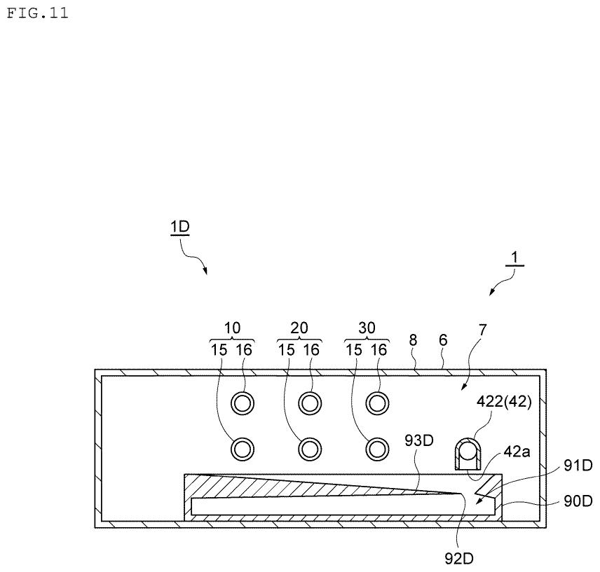

Also, for example, like a deaerator 1C illustrated in FIG. 10 and a deaerator 1D illustrated in FIG. 11, the container may have a liquid collecting portion in a funnel shape having the width thereof increased as going upward from an opening that opens the liquid storage space upward.

FIG. 10 is a schematic cross-sectional view of the deaerator corresponding to FIG. 4 in another example. In the deaerator 1C illustrated in FIG. 10, the top of a liquid storage space 91C of a container 90C is narrowed; in other words, an opening 92C that opens the liquid storage space 91C upward is narrowed. The container 90C then has a liquid collecting portion 93C in a funnel shape having the width thereof increased as going upward from the opening 92C.

In the deaerator 1C, the opening 92C of the container 90C is narrowed, but the container 90C has a liquid collecting portion 93C in a funnel shape having the width thereof increased as going upward from the opening 92C, thereby allowing this to guide the liquid into the opening 92C from a position apart from the opening 92C. Thus, even if the opening 92C of the container 90C is narrow and the outlet port 42a of the discharge pipe portion 42 is apart from the opening 92C, the liquid that is discharged from the outlet port 42a of the discharge pipe portion 42 may be properly guided into the container 90C. In addition, the upper part of the liquid storage space 91C is narrowed thereby narrowing the opening 92C; this enables to suppress bouncing and splashing of the liquid in the liquid storage space 91C to outside the liquid storage space 91C, and also suppress spilling-out of the liquid from the liquid storage space 91C even when the container 90C is knocked over or the like.

FIG. 11 is a schematic cross-sectional view of a deaerator corresponding to the XI-XI line in FIG. 2 in another example. In a deaerator 1D illustrated in FIG. 11, a container 90D extends from below the outlet port 42a of the discharge pipe portion 42 to below each of the connector portion 15 and the connector portion 16 of the deaerating modules 10, 20, and 30. The upper portion of a liquid storage space 91D of the container 90D is narrowed, thereby narrowing an opening 92D, which opens the liquid storage space 91D upward. The container 90D then has a liquid collecting portion 93D in a funnel shape having the width thereof increased as going upward from the opening 92D. The opening 92D is located below the outlet port 42a of the outlet pipe portion 42, and the liquid collecting portion 93D extends from below the outlet port 42a of the outlet pipe portion 42 to below each of the connector portion 15 and the connector portion 16 of the deaerating modules 10, 20, and 30.

In this deaerator 1D, the container 90D extends from below the outlet port 42a of the discharge pipe portion 42 to below each of the connector portion 15 and the connector portion 16 of the deaerating modules 10, 20, and 30, so that in the event that the liquid leaks from each of the connector portion 15 and the connector portion 16 of the deaerating modules 10, 20, and 30 to the accommodation space 7, the liquid that leaks to this accommodation space 7 may also be stored in the container 90D. The opening 92D of the container 90D is narrowed, and the container 90D has the liquid collecting portion 93D in a funnel shape having the width thereof increased as going upward from the opening 92D; with this configuration, it is possible to guide the liquid that is discharged from the outlet port 42a of the discharge pipe portion 42 and the liquid that has leaked from each of the connector portion 15 and the connector portion 16 of the deaerating modules 10, 20, and 30 to the opening 92D even if these members are apart from the opening 92D. Therefore, even when the opening 92D of the container 90D is narrow and the outlet port 42a of the discharge pipe portion 42 is apart from the opening 92D, it is possible to properly guide the liquid that is discharged from the outlet port 42a of the discharge pipe portion 42 and the liquid that has leaked from each of the connector portion 15 and the connector portion 16 of the deaerating modules 10, 20, 30 into the container 90D. In addition, the upper part of the liquid storage space 91D is narrowed thereby narrowing the opening 92D, so that it may suppress splashing of the liquid in the liquid storage space 91D to outside the liquid storage space 91D, and also to suppress spilling-out of the liquid from the liquid storage space 91D even if the container 90D is knocked over or the like.

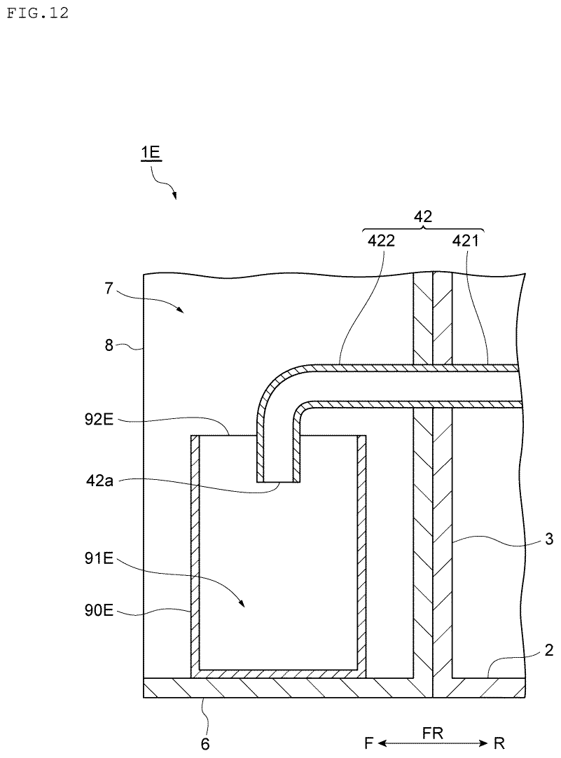

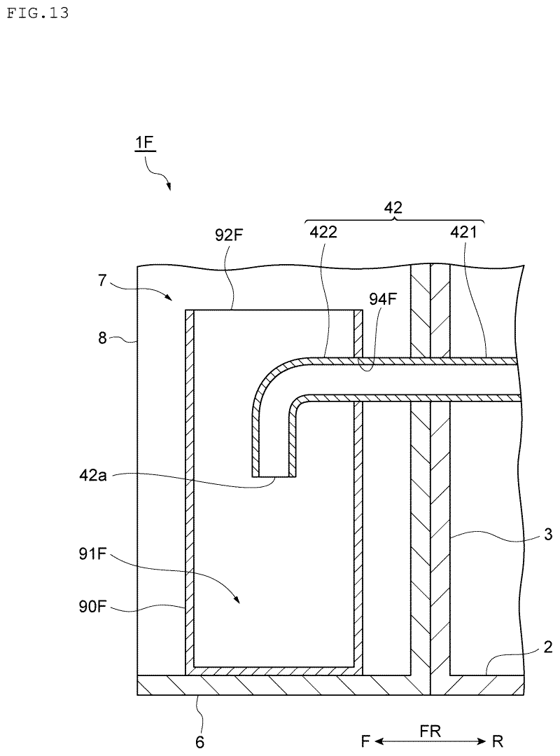

Also, for example, like a deaerator 1E illustrated in FIG. 12 and a deaerator 1F illustrated in FIG. 13, the outside discharge pipe portion may be inserted into the liquid storage space of the container.

FIG. 12 is a schematic cross-sectional view of the deaerator corresponding to FIG. 4 in another example. In the deaerator 1E illustrated in FIG. 12, the outside discharge pipe portion 422 is inserted into a liquid storage space 91E through an opening 92E of a container 90E, in which the outlet port 42a of the discharge pipe portion 42 is located below the opening 92E of the container 90E.

In this deaerator 1E, the outside discharge pipe portion 422 is inserted into the liquid storage space 91E through the opening 92E of the container 90E, thereby allowing the liquid that is discharged from the outlet port 42a of the discharge pipe portion 42 to easily enter the container 90E.

FIG. 13 is a schematic cross-sectional view of the deaerator corresponding to FIG. 4 in another example. In a deaerator 1F illustrated in FIG. 13, a container 90F has an opening 94F that opens a liquid storage space 91F to the outside, in addition to an opening 92F that opens the liquid storage space 91F upward. The opening 94F is formed, for example, on the side wall of the container 90F to open the liquid storage space 91F to the side thereof. The outside discharge pipe portion 422 is inserted into the liquid storage space 91F through the opening 94F of the container 90F, and the outlet port 42a of the discharge pipe portion 42 is located below the opening 92F of the container 90F.

The space between the outside discharge pipe portion 422 and the opening 94F may or may not be sealed.

In this deaerator 1F, the outside discharge pipe portion 422 is inserted into the liquid storage space 91F through the opening 94F of the container 90F, thereby allowing the liquid that is discharged from the outlet port 42a of the discharge pipe portion 42 to easily enter the container 90F. Moreover, because the opening 94F is formed in the side wall of the container 90F, this allows the outside discharge pipe portion 422 to be inserted into the liquid storage space 91F even if the height of the container 90F is high.

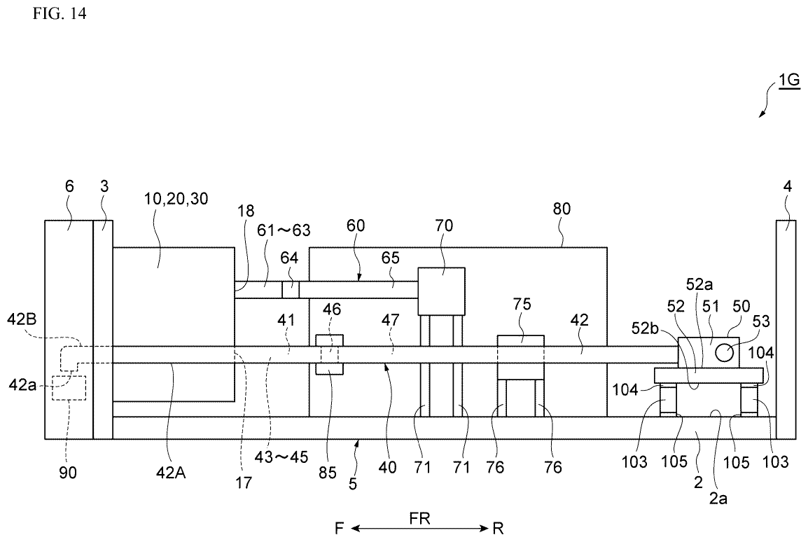

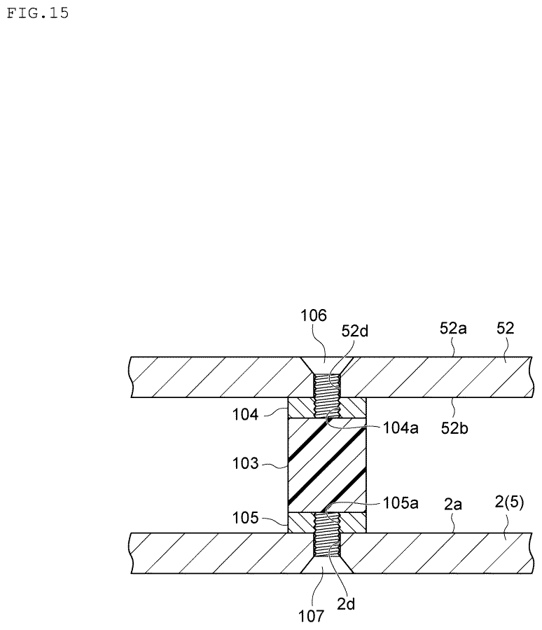

In addition, for example, the vibration-absorbing member may not be directly attached to the housing and the discharge device, but may be attached to the housing and the discharge device via other members. FIG. 14 is a schematic side view of a deaerator of another example. FIG. 15 is an enlarged cross-sectional view of a portion around the vibration-absorbing member of the deaerator illustrated in FIG. 14 In a deaerator 1G illustrated in FIG. 14 and FIG. 15, a vibration-absorbing member 103 is formed in a columnar shape, such as a cylinder column or a square column. An upper plate 104 having a threaded groove 104a is connected to the upper end, which is the tip of one side of the vibration-absorbing member 103, and a lower plate 105 having a threaded groove 105a is connected to the lower end, which is the tip of the other side of the vibration-absorbing member 103. The upper plate 104 is fixed to the fixing plate 52 by a screw 106 inserted into a through hole 52d of the fixing plate 52 and screwed into the threaded groove 104a of the upper plate 104; the bottom plate 105 is fixed to the bottom plate 2 by a screw 107 inserted into a through hole 2d of the bottom plate 2 and screwed into the threaded groove 105a of the lower plate 105. As a result, the vibration-absorbing member 103 is interposed between the bottom plate 2 of the housing 5 and the fixing plate 52 of the discharge device 50, and whereby the discharge device 50 is supported on the bottom plate 2 of the housing 5.

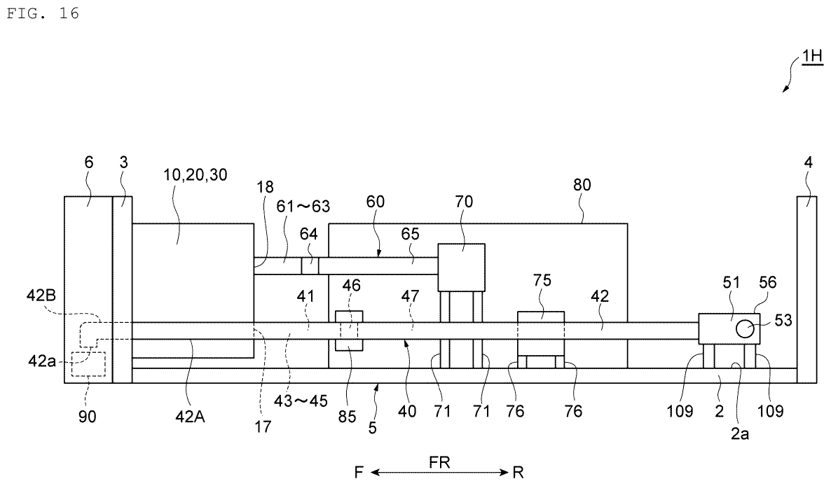

In addition, for example, the vibration-absorbing member may also be attached to the pump of the discharge device, rather than to the fixing plate of the discharge device. FIG. 16 is a schematic side view of a deaerator of another example. In a deaerator 1H illustrated in FIG. 16, a discharge device 56 has the pump 51 similar to the above embodiment, but does not have a configuration corresponding to the fixing plate of the above embodiment. A vibration-absorbing member 109 is attached directly or indirectly to the pump 51 and to the bottom plate 2. The shape of the vibration-absorbing member 109 and the attaching structure of the vibration-absorbing member 109 to the pump 51 and to the bottom plate 2 may be similar to, for example, the shape of the vibration-absorbing member 101 and the attaching structure of the vibration-absorbing member 101 to the fixing plate 52 and to the bottom plate 2 as illustrated in FIG. 7, and also may be similar to the shape of the vibration-absorbing member 103 and the attaching structure of the vibration-absorbing member 103 to the fixing plate 52 and to the bottom plate 2, as illustrated in FIG. 15.

### Industrial Applicability

The present invention may be used as the deaerator for a liquid chromatography, for a gas chromatography, for a biochemical analyzer, for an inkjet filling device, among other things.

### REFERENCE SIGNS LIST

1, 1A, 1B, 1C, 1D, 1E, 1F, 1G, 1H deaerator
2 bottom plate
2a upper surface
2c screw hole
2d through hole
3 front plate
4 rear plate
5 housing
6 front panel
7 accommodation space
10, 20, 30 deaerating module
11 tube
12 tube unit
12a inlet port
12b discharge port
13 housing
13a opening
14 lid
15 connector portion
16 connector portion
17 discharge nozzle portion
17a discharge port
18 release nozzle portion
18a release port
40 vacuum piping
41 suction pipe portion
42, 42A discharge pipe portion
42a . outlet port
43 to 45 discharge piping portion
46 discharge collecting portion
47 piping portion
48 detection piping portion
50 discharge device
51 pump
52 fixing plate
52a upper surface
52b lower surface
52c through hole
52d through hole
53 motor
54 suction port
55 discharge port
56 discharge device
60 atmospheric release piping
61, 62, 63 release piping portion
64 release collecting portion
65 piping
66 end portion
70 atmospheric release valve
71 leg
75 regulating valve
76 leg
80 control unit
85 detector
90, 90B, 90C, 90D, 90E, 90F container
90B1 non-translucent portion
90B2 translucent portion
91, 91C, 91D, 91E, 91F liquid storage space
92, 92C, 92D, 92E, 92F opening
93C, 93D liquid collecting portion
94F opening
101 vibration-absorbing member
101a neck portion
101b upper widened diameter portion
101c lower widened diameter portion
101d through hole
102 screw
103 vibration-absorbing member
104 upper plate
104a threaded groove
105 lower plate
105a threaded groove
106 screw
107 screw
109 vibration-absorbing member
421, 421A inside discharge pipe portion
422, 422A outside discharge pipe portion
422A1 base pipe portion
422A2 translucent pipe portion
FR front-rear direction
F front direction
R rear direction
S1 fluid flowing space
S2 depressurized space

1. A deaerator comprising:
a deaerating module having a tube unit that has gas permeability and partitions between a fluid flowing space and a depressurized space;
a vacuum piping having a suction pipe portion that is connected to the deaerating module to communicate with the depressurized space in the deaerating module and a discharge pipe portion having an outlet port opened to outside;
a discharge device that is configured to be connected to the suction pipe portion and to the discharge pipe portion to discharge a gas from the suction pipe portion to the discharge pipe portion;
a housing that has a bottom plate and a front plate erected from the bottom plate and mounts the discharge device above the bottom plate and behind the front plate; and
a container having a liquid storage space to store a liquid that is discharged from the outlet port of the discharge pipe portion, wherein
the discharge pipe portion has an inside discharge pipe portion that is located behind the front plate and is connected to the discharge pipe portion and an outside discharge pipe portion that is located in front of the front plate and has the outlet port formed.

2. The deaerator according to claim 1, further comprising a control unit that controls activation and deactivation of the discharge device, wherein
the housing mounts the control unit above the bottom plate and behind the front plate.

3. The deaerator according to claim 1, wherein at least part of the outside discharge pipe portion and the container is translucent to allow an interior thereof to be seen from outside thereof.

4. The deaerator according to claim 1, wherein the container is translucent to allow an interior thereof to be seen from outside thereof.

5. The deaerator according to claim 1, wherein the outside discharge pipe portion has a base pipe portion that is continuous from the inside discharge pipe portion, and has a translucent pipe portion that has the outlet port, and is connected to the base pipe portion, and is translucent to allow an interior thereof to be seen from outside thereof.

6. The deaerator according to claim 1, wherein
the container has an opening that opens the liquid storage space upward, and
the opening of the container is located below the outlet port of the discharge pipe portion.

7. The deaerator according to claim 6, wherein the container has a liquid collecting portion in a funnel shape having a width thereof increased as going upward from the opening.

8. The deaerator according to claim 1, wherein
the container has an opening that opens the liquid storage space to outside, and
the outside discharge pipe portion is inserted into the liquid storage space through the opening.

9. The deaerator according to claim 1, wherein at least part of the vacuum piping is formed of a resin composition containing a polyolefin and a styrene thermoplastic elastomer.

10. The deaerator according to claim 2, wherein at least part of the outside discharge pipe portion and the container is translucent to allow an interior thereof to be seen from outside thereof.

11. The deaerator according to claim 2, wherein the container is translucent to allow an interior thereof to be seen from outside thereof.

12. The deaerator according to claim 3, wherein the container is translucent to allow an interior thereof to be seen from outside thereof.

13. The deaerator according to claim 2, wherein the outside discharge pipe portion has a base pipe portion that is continuous from the inside discharge pipe portion, and has a translucent pipe portion that has the outlet port, and is connected to the base pipe portion, and is translucent to allow an interior thereof to be seen from outside thereof.

14. The deaerator according to claim 3, wherein the outside discharge pipe portion has a base pipe portion that is continuous from the inside discharge pipe portion, and has a translucent pipe portion that has the outlet port, and is connected to the base pipe portion, and is translucent to allow an interior thereof to be seen from outside thereof.

15. The deaerator according to claim 2, wherein
the container has an opening that opens the liquid storage space upward, and
the opening of the container is located below the outlet port of the discharge pipe portion.

16. The deaerator according to claim 3, wherein
the container has an opening that opens the liquid storage space upward, and
the opening of the container is located below the outlet port of the discharge pipe portion.

17. The deaerator according to claim 2, wherein
the container has an opening that opens the liquid storage space to outside, and
the outside discharge pipe portion is inserted into the liquid storage space through the opening.

18. The deaerator according to claim 3, wherein
the container has an opening that opens the liquid storage space to outside, and
the outside discharge pipe portion is inserted into the liquid storage space through the opening.

19. The deaerator according to claim 2, wherein at least part of the vacuum piping is formed of a resin composition containing a polyolefin and a styrene thermoplastic elastomer.

20. The deaerator according to claim 3, wherein at least part of the vacuum piping is formed of a resin composition containing a polyolefin and a styrene thermoplastic elastomer.
